(19) United States
(12) Patent Application Publication
(10) Pub. No.: US 2013/0251852 A1
(43) Pub. Date: Sep. 26, 2013

(54) REDUCED-FAT NATURAL BUTTER PRODUCT AND METHODS OF MANUFACTURING THE SAME

(71) Applicants: Todd Landon, Mound, MN (US); Cara Nelson, Arden Hills, MN (US); Glenn H. Ward, Lauderdale, MN (US)

(72) Inventors: Todd Landon, Mound, MN (US); Cara Nelson, Arden Hills, MN (US); Glenn H. Ward, Lauderdale, MN (US)

(21) Appl. No.: 13/424,744

(22) Filed: Mar. 20, 2012

(51) Int. Cl. A23C 15/16; A23C 15/02

(52) U.S. Cl. 426/43; 426/664; 426/334; 426/581; 426/61

(57) ABSTRACT

A method of forming a reduced-fat butter product. The method includes churning cream to create buttermilk and concentrated milkfat. The buttermilk is concentrated to increase solids in the buttermilk by about three times to form a concentrated buttermilk. The concentrated buttermilk is blended with the concentrated milkfat to form a final reduced-fat butter product comprising no more than 60 percent fat.

### FIELD OF THE INVENTION

The present disclosure relates to a reduced fat natural butter product and methods of making the same. More particularly, the present disclosure relates to all natural, preservative free, reduced-fat butter products utilizing components naturally found in milk and ingredients common and usual to butter, with similar product performance as full fat butter and methods for making the same.

### BACKGROUND OF THE INVENTION

Butter preparation methods represent some of the oldest techniques for utilizing fat components that are found in milk. Butter manufacture has been accomplished in one form or another for over 4500 years. Over the centuries, butter has been used in sacrificial worship ceremonies, for medicinal and cosmetic purposes, and as a human food.

Butter production techniques generally evolved into more sophisticated techniques as new forms and uses of equipment developed. For example, the barrel churn made its appearance toward the end of the 18th century when non-wooden manufacturing materials entered widespread use in creaming and butter making equipment. These advances led to advances in cream separation techniques, and by 1879, continuous operation cream separators were known in Sweden, Denmark, and Germany. Likewise, butter production evolved from an individual farm activity to a factory based technique with the introduction of milk pooling systems for creamery operation in the 1870s. Later advances in fat quantification techniques, pasteurization, refrigeration, and bacterial culture usage further advanced the art of butter production.

Advances in butter production technology helped make butter a staple item in the kitchen. Certain components of butter, such as interfacial butter solids, give butter-based baked goods properties that are not generally achievable by reduced fat and/or light butter. For example, butter melts somewhat evenly in the mouth to yield a smooth, rich mouth-feel that is characteristic of butter. As another example, the protein and lactose components of butter gives desirable browning characteristics to baked goods that incorporate butter. Also, the phospholipid portion of butter gives body to baked goods and gives the baked goods the characteristic rich flavor long associated with butter. Phospholipids, proteins, and sugars, such as lactose, are each components of interfacial butter solids.

Despite these highly desirable taste and baking properties associated with butter, butter consumption came under attack by nutritionists and the medical profession during the 1970s and 1980s because of links thought to exist between butter consumption and certain health conditions. Also, butter prices tend to be relatively volatile over the long term. These factors led to increasing use of butter substitutes, such as margarine and butter/margarine blends, that included fat sources in addition to, or other than, butterfat. These factors also led to formulation of reduced-fat butter substitutes, such as reduced-fat butter, low fat butter, and spreads with total fat concentrations of less than about 80 weight percent, to further reduce the amount of saturated fats and calories in the human diet.

In accordance with labeling requirements of regulatory authorities in the United States, such as the United States Department of Agriculture (U.S.D.A.), butter, reduced-fat butter, light butter, margarine, and spreads have particularized meanings. For example, under the U.S.D.A. definition, butter, reduced-fat butter, and light butter are made exclusively from milk and/or cream, though butter, reduced-fat butter, and light butter may each contain additional coloring matter and salt. Under the U.S.D.A. regulations, butter may not contain less than 80 weight percent milkfat (also referred to as butterfat); reduced-fat butter contains 60 weight percent milkfat, or less; and low fat butter contains 40 weight percent milkfat, or less. Also, under the U.S.D.A. definition, margarine may be made from milk and/or cream, along with fat sources other than milk and cream, though margarine must contain at least 80 weight percent total fat. Finally, under the U.S.D.A. definitions, a spread may be made from milk and/or cream along with fat sources other than milk and cream, and may contain less than 80 weight percent total fat.

The meanings of “butter”, “reduced-fat butter”, “light butter”, “margarine”, and “spread” vary significantly between different countries due to varying regulatory requirements from country to country. Thus, while a particular material may be properly referred to as light butter in the U.S., it may be improper to refer to that same material as light butter in another country, and vice versa. Unless otherwise indicated, references made herein to “reduced-fat butter”, “light butter”, “margarine”, and “spread” are generally based upon the U.S.D.A. definitions for these materials for purposes of clarity and consistency, though it is to be understood that the light butter and other butter-based products, such as reduced-fat butter and butter-containing spreads, that may be produced in accordance with the present invention are not limited by any definitional or regulatory requirement(s) of any particular country or government entity, except as otherwise indicated subsequently herein.

Typically, during the manufacturing process for butter, whole milk may be separated into cream and skim milk. The cream portion (which may be 20-40 percent fat) may then be churned to make butter, a process which generally produces equal amounts butter and buttermilk. For example, when 100 lbs of 40 percent fat cream is churned into butter, 50 lbs of butter and 50 lbs of a stream of buttermilk is produced. Skim milk and buttermilk may be generally viewed as by-products of the butter making process. Skim milk can either be packaged as salable goods or dried for sale or use as non-fat dry milk. Like skim milk, buttermilk can either be packaged as salable goods or dried for sale for use as dried buttermilk. Generally speaking, the manufacture, storage and marketing of non-fat-dry milk (nfdm) and dry buttermilk are subject to difficult market forces.

In some cases, manufacturing plants may concentrate buttermilk (i.e. remove the moisture) and may ship condensed milk in order to avoid shipping water, or may dry buttermilk to a powder form such as through a spray drying process. Each of these processes for converting liquid buttermilk requires energy input and are typically done in a step-by-step process. Accordingly, processing of, storage of, and also the usefulness of the buttermilk portion of the butter making process may be unsatisfactory from a cost-effectiveness, efficiency, energy, storage, and/or use standpoint.

### BRIEF SUMMARY OF THE INVENTION

Implementations provide a process for making a product using the buttermilk portion of the butter making process, whereby the resulting product may be useful, relatively healthy, and may also be relatively cost-effective and efficient to make. Accordingly, the present disclosure, in one embodiment, relates to a method of forming a reduced-fat butter product. The method includes churning cream to create buttermilk and concentrated milkfat. The buttermilk is concentrated to increase solids in the buttermilk by three times to form a concentrated buttermilk. The concentrated buttermilk is blended with the concentrated milkfat to form a final reduced-fat butter product comprising no more than 60 percent fat.

In another embodiment, a reduced-fat natural butter product is disclosed. The product includes concentrated milkfat and concentrated buttermilk blended to form a final reduced-fat natural butter product comprising no more than 60 percent fat by weight of the total product.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 is a flowchart showing one method of forming a reduced-fat butter product, according to one embodiment of the present disclosure.

FIG. 2A is a view of butter magnified 100×.

FIG. 2A is a view of reduced fat butter magnified 100×.

### DETAILED DESCRIPTION

The present disclosure relates to novel and advantageous reduced-fat butter products. More particularly, the present disclosure relates to all-natural, preservative free, reduced-fat butter products utilizing components naturally found in milk and ingredients common and usual to butter without sacrificing product performance as compared to full fat butter and methods for making the same. Even more particularly, the present disclosure relates to concentrating the buttermilk by-product stream and in some embodiments, reintroducing the concentrated buttermilk stream into the butter making process to create a reduced-fat butter that takes advantage of the naturally occurring emulsifiers/interfacial solids that reside in native buttermilk and which help give butter its special performance characteristics in cooking/baking.

Embodiments of the present disclosure may advantageously leverage current technologies and processes to: add value to the by-product buttermilk stream; reduce the energy input used in the buttermilk drying process; reduce storage of buttermilk powder; and/or increase churn capacity without increasing inputs to the churn.

The reduced-fat butter product of the present disclosure in some embodiments may perform generally on par with full-fat butter (i.e. “butter”). The comparable performance may in part be due to the finished product of some embodiments having a moisture content comparable to a 70 percent fat product, as opposed to a 60 percent fat product, for example. It is recognized in the art that spread products with a 70 percent fat content may be significantly more similar to their full-fat counterparts than lower fat spreads. Naturally occurring non-fat solids derived from the butter making process are used to reduce the overall fat content, while providing enhanced performance over typical reduced-fat products because the fat is not replaced on a one-to-one basis with an aqueous system. According to aspects of the present disclosure, all solids used to reduce the fat and moisture are advantageously native to and/or typical to the traditional butter making process.

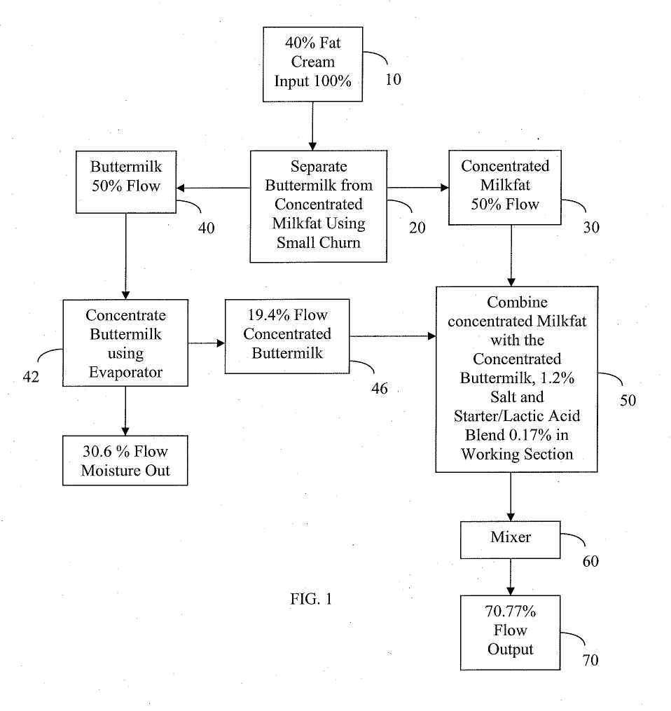

FIG. 1 shows a method for making one embodiment of the present disclosure. The starting material 10 for the process may be about a 40 percent fat cream. In other embodiments the cream that comprises the starting material may be concentrated to approximately about 67 percent solids by evaporation, for example, prior to churning. The cream may be pasteurized, for example, at greater than or about 185° F. for greater than or about 15 seconds. The cream may be cooled to less than or about 45° F. for curing for greater than or about 6 hours. The cream may then be tempered to about 52° F. and churned 20 to create generally equal parts concentrated milkfat 30 and buttermilk 40. The churning produces a water-in-oil emulsion.

In some embodiments, the concentrated milkfat 30 may be fresh churned butter (salted or unsalted). The concentrated milkfat 30 may have a composition of about 83 percent fat; 17 percent serum; 15.5 percent moisture and 1.5 percent solids. While in other embodiments, the concentrated milkfat may comprise re-melted butter, anhydrous milkfat or butter fractions, for example. In still other embodiments, the milkfat may comprise centrifuged milkfat, or in still other embodiments the milkfat may comprise dry cream that may be both reconstituted and centrifuged, for example.

The buttermilk 40 churned 20 from the cream 10 may be processed through an evaporator 42 to obtain a concentrated buttermilk product 46, which may contain about three times the original solids compared to the buttermilk 40. In some embodiments, the concentrated buttermilk product 46 may be about 20-36 percent solids non-fat, about 73 percent moisture, and about less than 3 percent fat. In further embodiments, the concentrated buttermilk product 46 may be about 18 percent to about 40 percent solids non-fat; about 20 percent to about 36 percent solids non-fat; about 20 percent to about 30 percent solids non-fat; or any individual values or ranges between the ranges mentioned may also be used. The moisture content of the concentrated buttermilk product 46 may be about 60-82 percent moisture and any individual values or ranges therebetween. The fat content of the concentrated buttermilk product 46 may be less than about 5 percent fat.

It is believed that the minimal processed state of the concentrated buttermilk solids provides a beneficial effect in the final product and accordingly in some cases may be preferred. Nonetheless, in another embodiment the concentration of the buttermilk may be performed using thermal evaporation concentration, while in other embodiments ultra-filtration or reverse osmosis may be used. In still other less preferred embodiments, the buttermilk may be replaced by skim milk, or in still other embodiments the buttermilk component may comprise dry buttermilk or skim milk powder that may be reconstituted, for example.

The concentrated buttermilk 46 may then be added to the working section 50 of the churn, where the concentrated buttermilk 46 may be combined with the concentrated milkfat 30, as well as salt and a starter/lactic blend. The mixture may be blended at a temperature of about 61.7° F. The mixture may be blended in a continuous churn fashion, in some embodiments. In some embodiments, a pinmixer may be used to help work the mixture into a reduced-fat butter product 70. Additional ingredients may be added to enhance flavor, texture, performance, or any other aspect of the final product or any intermediary. In some embodiments, for example, non-fat dry milk, dry cream, whey solids, cheese solids, colorants, vitamins, minerals, flavorings, and/or any other suitable additive may be included.

The process may also include a preservative and flavor combination system utilizing a fermentation process for the development of flavor, reduced pH, and natural starter culture microbial inhibition. In such embodiments, the concentrated buttermilk may be cultured and enzyme treated. In other embodiments, the concentrated milkfat may be cultured or enzyme treated. In some embodiments, a target pH of less than about 4.6; a target pH range of between 4.4 to 4.8; or a target pH of less than 5.2 may be achieved by using citric acid, for example, or any other suitable compound or combination of compounds that may be used to control pH.

The final product may be packaged in any suitable manner. For example, the final product may be packaged as sticks of reduced-fat butter, or as a tub of spreadable reduced-fat butter.

Examples of process options for blending the milkfat and buttermilk components include:

i. Tempered Blending: Milkfat 30 may be tempered to approximately 16.5° C. (61.7° F.) as a product of a continuous or batch chum. The tempered milkfat may be blended with the condensed buttermilk component 46 before processing through a swept surface heat exchanger to crystallize, chill and work the product into the desired final texture.

ii. Hot Process Blending: Milkfat 30 may be re-melted into butter 66° C. (150° F.) which may then be cooled to 43° C. (110° F.) and blended with the condensed buttermilk component before processing through a swept surface heat exchanger to crystallize, chill and work the product into the desired final texture.

iii. Injection Blending: Solidified, plastic milkfat 30 may be injected with a blend of concentrated buttermilk component 46 in an enclosed system which then feeds into a swept surface heat exchanger to crystallize, chill and work the product into the desired final texture.

iv. Dual Emulsion Blending: Milkfat 30 may be separated into fractions based on melting point and used to construct a two phase final product. The hard fraction may be separated at about 19° C. can be melted and blended with the concentrated buttermilk 46 to form a primary emulsion using a homogenizer. The subsequent primary emulsion is then blended into a melted secondary phase composed of the remaining soft fraction which may also be supplemented with non-fractionated milkfat if desired. The secondary phase is maintained while suspending the primary phase so that two distinct phases coexist. In this case the primary emulsion is suspended into the soft fraction so that the final product has increased spreadability attributes.

Concentrated buttermilk and milkfat components may be processed using a combination of one or more of the above-described blending processes. In some implementations the milkfat may be non-fractionated. Further, the concentrated buttermilk and milkfat components may be subjected one or more processes disclosed in U.S. Pat. No. 7,927,646, entitled “Refrigeration-Temperature Spreadable Butter-Based Product,” and having a common inventor, which is herein incorporated by reference in its entirety for any useful purpose, and such processes may be used alone or in combination with the processing steps disclosed herein.

In some implementations, the butter product may be subjected to a whipping process by injecting an inert gas, such as nitrogen, into the butter product to provide additional spreadability attributes.

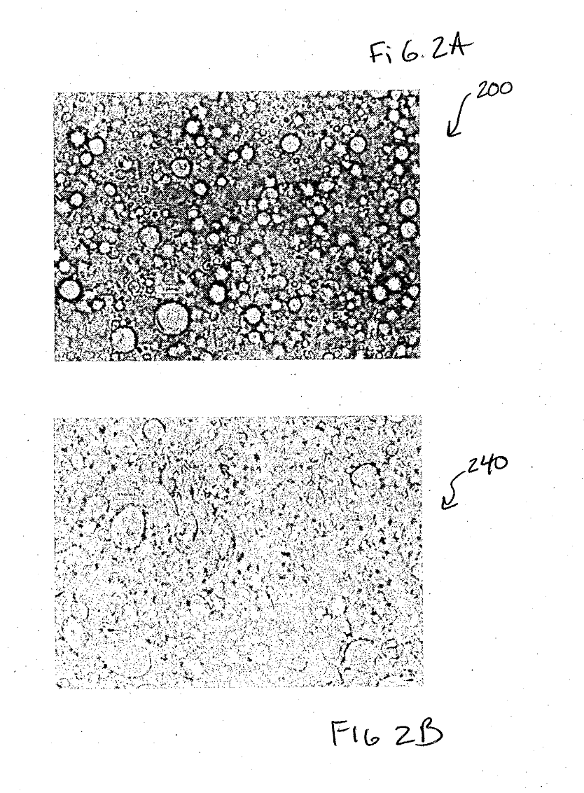

The process of the present disclosure may use a greater percentage of the buttermilk by-product stream than that of traditional processes for making butter, while reducing the overall moisture content of a reduced-fat butter product and providing a reduced fat butter. Furthermore, volumes of continuous and discontinuous phases may provide interference of crystal-crystal bonding to yield a softer overall refrigerated product. Volume/volume interference models may be used to reduce crystal-crystal bonding in the finished product, resulting in an increased softness of the product at refrigeration temperatures. The volume of the dispersed phase aqueous system occupies space between the crystalline fat matrix that comprises the continuous phase of the finished product. This higher volume dispersed aqueous phase inhibits crystal-crystal bonding by providing a serum layer that the crystals are less likely to cross, as may be seen by comparing FIGS. 2A and 2B. FIG. 2A shows a view of butter at 100× magnification, while FIG. 2B shows a reduced fat butter at 100× magnification.

As stated earlier, embodiments of the present disclosure may advantageously leverage current technologies and processes to: add value to the by-product buttermilk stream; reduce the energy input used in the buttermilk drying process; reduce storage of buttermilk powder; and/or increase churn capacity without increasing inputs to the churn. Value may be added to the buttermilk stream because dry buttermilk and nonfat dry milk currently tend to price at approximately $1.00/1b of solids, with butterfat pricing slightly higher than that. If buttermilk solids are concentrated to 24 percent in the processing stream, as is the case with embodiments of the present disclosure, in order to gain improved fat replacing performance (removal of water and leveraging of naturally occurring dairy proteins at increased concentration in their native state), such buttermilk solids may be used to replace butterfat in a reduced fat butter stick product while not sacrificing significant performance in the finished butter product.

Energy input may be reduced in the buttermilk drying process because buttermilk may be used in embodiments of the present disclosure after the first effect of the buttermilk concentrating process, as opposed to the second or third effects, or the drying stage, for example. Not needing to process the buttermilk through a second and/or a third effect, thereby results in an energy savings.

Storage of buttermilk powder may also be reduced because the buttermilk that would have been dried, packaged, palletized, stored, and/or shipped is no longer dried and therefore no longer needs to be packaged, stored, shipped, etc. For every 100,000 lbs of finished reduced fat butter (RFB) of the present disclosure that is made, approximately 6,570 lbs of dry buttermilk is not generated.

Churn capacity is also increased by using embodiments of the present disclosure without increasing the inputs to the churn. This is the case because the concentrated buttermilk stream may be reintroduced after the churning process. For example, in a typical butter making process, 100 lbs of cream input into the churn would result in 50 lbs of butter output and 50 lbs of buttermilk. According to embodiments of the present disclosure, however, the same 100 lbs of cream input into the churn would result in 70 lbs of finished product, because another 20 lbs of the buttermilk may be fed back into the process to make the finished product, which may increase the churn output by 40 percent. In addition, the buttermilk native to the cream prior to churning to be used to make the finished product, thereby increasing churn capacity and reducing energy input.

In some embodiments of the present disclosure, an acidic compound, for example, citric acid and/or other compounds may be used as the main or the only acidifier. The acidic compound may be used to adjust the final product pH to about 4.6. One embodiment of a final product composition according to the present disclosure may be made from a blend of cultured buttermilk and concentrated milkfat and may include: less than about 60 percent fat; and approximately 1.70 percent salt, 7.65 percent solids non-fat and 30.65 percent moisture. In further embodiments, a final product composition formed of the blend of cultured buttermilk and concentrated milkfat may include: at least 40 percent and no more than 60 percent fat; between 1-3 percent salt; 5-8 percent solids non-fat and 28-32 percent moisture. In yet further embodiments, a final product composition formed of the blended concentrated buttermilk and concentrated milkfat may include: 70.65 percent unsalted butter; 27.41 percent solids concentrated buttermilk; 1.70 percent salt; and 0.24 percent starter/lactic acid blend.

In some embodiments of the present disclosure, the concentrated buttermilk may be cultured and/or enzyme treated. Accordingly, after cream is churned to create concentrated milkfat and buttermilk, the buttermilk portion may be concentrated to a desired solid content (e.g. about 24 percent) and then pasteurized. The pasteurized and concentrated buttermilk may then be delivered to a holding vessel, for example a holding vessel with the temperature control set to about 32° C./90° F. A starter culture may then be added to the tank under aseptic conditions. The mix may then be appropriately agitated so that the culture may be thoroughly dispersed. In some embodiments, an enzyme may then be added and dispersed along with the culture or may be added instead of the culture. In some embodiments a lactase enzyme may be added at a rate of about 0.005 percent to alter the sugar profile of the concentrated buttermilk component, thus affecting finished product flavor. The mixture including the enzyme may be incubated at about 32° C. (90° F.) until a pH of about 4.60 is reached. Once about 4.6 pH is reached, the cultured buttermilk may be cooled until final blending. Any final pH adjustment may be made with citric acid at the time of final product blending.

Example of Cultured Buttermilk Procedure:

Concentrated buttermilk was pasteurized, placed in a silo at 4.5° C. and adjusted to 24 percent solids at a pH of 6.31. The following cultures were then added to the 300 gallons of concentrated buttermilk: 0.005 percent of Danisco Holdbac YM-C; 0.005 percent Danisco Choozit 1001, and 0.005 percent of fungal lactase enzyme (80,000 ALU/g). The mixture was then blended for 10 minutes to fully disperse the cultures and enzyme, and slowly agitated for 30-40 minutes thereafter. The temperature was held at 32 C (90° F.) for approximately 10 hours until a final pH of 4.6 was attained.

A final reduced-fat butter product according to the present disclosure that includes no more than 60 percent fat was subjected to performance testing. Biscuits and chocolate chip cookies were made using: the reduced-fat butter of the present disclosure; light butter; and full fat butter. It was found that the reduced-fat butter of the present disclosure performed similar to full-fat butter especially with regard to baking.

A microbial challenge was conducted due to the higher moisture content of the reduced fat product in comparison to its full fat counterpart. The conclusion of the testing found variables at 7° C. (45° F.) inoculated with Listeria sp. yielded a slight decrease in growth overall throughout the 15 day study. The only sample that the Penicillium sp. levels did not increase in was the cultured product containing Danisco Choozit 1001 and Danisco HoldbacYM-C held at 7° C. (45° F.) and 18° C. (64° F.), which both yielded a slight decrease overall. The Penicillium levels increased dramatically in the control samples held at 18° C. (64° F.). Surprisingly, it was determined that the preferred embodiment is the cultured concentrated buttermilk due to its antimycotic and antipathogen efficacy.

Example of product using milkfat fractions: Milkfat fractions obtained by the controlled melting and cooling were obtained to form a hard fraction at 19° C. and a soft fraction separated at 8° C. The primary emulsion was made from 15 percent melted (150° F./65° C.) hard fraction obtained at 19° C. blended with 85 percent cultured concentrated buttermilk containing 24 percent solids and a pH of 4.5. The resulting blend was homogenized to obtain uniform small fat droplets distributed within the continuous water phase in a stable emulsion. To make the secondary emulsion, the primary emulsion (28 percent formula weight) was blended with salt (1.2 percent formula weight) and further diluted with a 10 percent salt brine solution (10.8 percent formula weight). This formed a thinner consistency, salted primary emulsion which was then folded into the melted (150° F./65° C.) blend of soft fraction obtained at 8° C. (40 percent formula weight) and non-fractionated milkfat (20 percent formula weight). The secondary emulsion was then run through Gerstenberg swept surface heat exchange equipment to achieve a final product that was solid and spreadable in a refrigerated state.

Although the present invention has been described with reference to preferred embodiments, persons skilled in the art will recognize that changes may be made in form and detail without departing from the spirit and scope of the invention.

We claim:

1. A method of forming a reduced-fat butter product, the method comprising:
churning cream to create buttermilk and concentrated milkfat;
concentrating the buttermilk to increase solids in the buttermilk by about three times to form a concentrated buttermilk;
blending the concentrated buttermilk with the concentrated milkfat to form a final reduced-fat butter product comprising no more than 60 percent fat.

2. The method of claim 1, wherein the final reduced-fat butter product has a pH of about 4.6.

3. The method of claim 2, wherein the pH is achieved at least in part by using a culture.

4. The method of claim 3, wherein the culture is an antimycotic producing strain starter culture.

5. The method of claim 2, wherein the pH is achieved at least in part by using an acid.

6. The method of claim 5, wherein the acid is citric acid.

7. The method of claim 2, further comprising adding an enzyme in with at least one of the concentrated buttermilk and the concentrated milkfat.

8. The method of claim 7, wherein the enzyme is lactase.

9. A reduced-fat natural butter product, comprising:
concentrated milkfat and concentrated buttermilk blended to form a final reduced-fat natural butter product comprising no more than 60 percent fat by weight of the total product.

10. The product of claim 9, wherein the final reduced-fat natural butter product has a moisture content comparable to a butter product having a 70 percent fat content.

11. The product of claim 9, wherein the starting material from which the concentrated milkfat and the concentrated buttermilk are derived is an about 40 percent fat cream.

12. The product of claim 9, wherein the concentrated milkfat is fresh churned butter.

13. The product of claim 9, the concentrated buttermilk that is blended with the milkfat is about 20-36 percent solids non-fat.

14. The product of claim 13, wherein the concentrated buttermilk has about 73 percent moisture content.

15. The product of claim 14, wherein the concentrated buttermilk has about 3 percent fat.

16. The product of claim 9, further comprising an enzyme added to at least one of the concentrated buttermilk and the concentrated milkfat.

17. The product of claim 9, further comprising a culture added to at least one of the concentrated buttermilk and the concentrated milkfat.

18. The product of claim 17, wherein the culture is an antimycotic producing strain starter culture.

19. The product of claim 9, wherein the final product has a pH of between about 4.4 and 4.8.

20. The product of claim 19, wherein the final product is packaged in one or more of stick form and tub form.
